(19) United States
(12) Patent Application Publication
(10) Pub. No.: US 2005/0144039 A1
(43) Pub. Date: Jun. 30, 2005

(54) System and method for healthcare management

(76) Inventors: Robyn Tamblyn, Montreal (CA); Allen Huang, Montreal (CA); Melodie Faucher, Montreal (CA); Roland Grad, Dollard des Ormeaux (CA)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/975,046

(22) Filed: Oct. 27, 2004

Related U.S. Application Data
(60) Provisional application No. 60/515,707, filed on Oct. 31, 2003.

(30) Foreign Application Priority Data
Oct. 31, 2003 (CA) 2,447,731

(51) Int. Cl. G06F 17/60

(52) U.S. Cl. 705/2; 705/4

(57) ABSTRACT

A healthcare management system for automatically generating a patient-specific health problem list for assisting physicians at the time of prescribing. The system receives information regarding insurance claims for medical services, on a basis of which a control unit determines ailments with which patients are potentially afflicted. The system may also receive information regarding pharmaceutical claims for prescription drug dispensation, on a basis of which the control unit will attempt to determine ailments with which patients are potentially afflicted. The system may also receive information regarding physician diagnoses of patient medical conditions, on a basis of which the control unit determines ailments and allergies with which patients are potentially afflicted.

### CROSS-REFERENCES TO RELATED APPLICATION

The present application claims the benefit under 35 U.S.C. 119(e) of U.S. Provisional Patent Application Ser. No. 60/515,707, filed Oct. 31, 2003, hereby incorporated by reference herein.

### FIELD OF THE INVENTION

The present invention generally relates to the field of healthcare management systems. More particularly, the present invention relates to a system and method for assisting physicians in making informed, optimal decisions related to drug prescription and disease management.

### BACKGROUND OF THE INVENTION

In the world of medicine and medical treatment, physicians and pharmacists must be familiar with a wealth of information concerning pharmaceutical products, in order to ensure optimal and safe treatment. There are in fact thousands of known drug interactions, drug-disease contraindications and drug-allergy contraindications to be taken into account by physicians when prescribing drugs to patients.

Medical treatment is rendered even more complicated since patients who have a number of health problems will often consult more than one physician. This makes it difficult for physicians to obtain complete information on all current health problems and medications of patients, and increases the risk of inappropriate and potentially health-threatening prescriptions.

It is no secret that, in order for a physician to make an informed diagnosis of a patient's medical condition and to determine a safe and effective drug prescription, the physician requires up-to-date information as to the patient's health problems and allergies. It is therefore desirable that such information be made readily available to the physician at the time of prescribing. Preferably, this information would be in electronic format, in view of the recent technological advances in the health care field, which have led to computer-based healthcare management systems and computerized prescribing applications.

Certain existing computer-based healthcare management systems, such as electronic health record databases, network distributed shared health record systems and electronic prescription applications, may already provide this type of information to physicians. However, these systems typically require that the physician or someone else explicitly input the necessary data (i.e. diagnostic and drug prescription information) to the system regularly, for updating the respective health records of the patients. This process can be tedious, time-consuming and inaccurate. The latter is especially true if the data is not input regularly to the system, or if manual mistakes are made when inputting the data.

Another approach that is used within computer-based drug and disease management systems in order to generate up-to-date information on patients' health problems and allergies is to extract and associate health problem data from detailed, electronic medical charts. This process is slow, costly and possibly incomplete, and is limited in terms of the amount of clinical decision support that can practically be presented to the physician at the time of prescribing.

The background information provided above clearly indicates that there exists a need in the industry to provide an improved system and method for providing physicians with up-to-date information on the health problems and allergies of their patients at the time of prescribing.

### SUMMARY OF THE INVENTION

The present invention provides in one broad aspect a healthcare management system having an input adapted to receive information regarding insurance claims for medical services, each insurance claim being associated with an individual to whom at least one medical service was provided. A control unit is operative to automatically determine from the information regarding each insurance claim at least one ailment with which the respective individual is potentially afflicted. The system also includes an output adapted to release information indicative of the at least one ailment.

In another broad aspect, the invention provides a healthcare management system having an input adapted to receive information regarding claims for drug dispensation, each claim being associated with an individual to whom at least one prescription drug was dispensed. A control unit is operative to automatically attempt to determine from the information regarding each claim one or more ailments with which the respective individual is potentially afflicted. The system also includes an output adapted to release information indicative of the one or more ailments.

In yet another broad aspect, the invention provides a healthcare management system having first and second inputs. The first input is adapted to receive information regarding insurance claims for medical services, each insurance claim being associated with an individual to whom at least one medical service was provided. The second input is adapted to receive information regarding claims for drug dispensation, each claim being associated with an individual to whom at least one prescription drug was dispensed. A control unit is operative to automatically generate for each individual a cumulative list of ailments with which the respective individual is potentially afflicted, on a basis of the information received at the first and second inputs. The system also includes an output adapted to release to a display the cumulative list of ailments for validation by a physician.

In other broad aspects, the invention provides various methods for automatically generating a list of patient-specific ailments suitable for use in healthcare management.

In a specific, non-limiting example of implementation, the healthcare management system implements an automated health problem list generator. This automated health problem list generator includes a functional entity that interacts with a healthcare knowledge database. The information processed by the functional entity may include:
“medical service information” regarding a particular medical service that has been rendered to a patient;
“drug dispensation information” regarding a particular prescription drug that has been dispensed to a patient; and
“physician diagnostic information” regarding a particular diagnosis of the medical condition of a patient that has been given by a physician.

The medical service information may be contained in medical service claim records received from an administrative source, such as a government or private insurance company. The functional entity extracts from each medical service claim record a patient identifier as well as an indication of the medical condition or ailment for which the medical service was performed.

On the basis of the patient identifiers and indications of ailments extracted from the medical service claim records, the functional entity is able to automatically generate patient-specific cumulative health problem lists, which are stored in the healthcare knowledge database. More specifically, on the basis of the patient identifier, the functional entity adds each new health problem revealed by a medical service claim record to the appropriate health problem list stored in the healthcare knowledge database.

The drug dispensation information may be contained in dispensed prescription records received from a remote clinical source (such as a pharmacy) and prescription claim records received from an administrative source (such as an insurance company), as well as in drug sample records received from a local clinical source (such as a hospital or private clinic). The functional entity extracts from each received record a patient identifier as well as an indication of the prescription drug dispensed to the patient.

Once the drug designation has been determined, the functional entity attempts to determine a patient ailment for which the drug was dispensed, by again consulting the healthcare knowledge database, which contains drug-disease relationship information. In a specific example, the healthcare knowledge database contains a table mapping prescription drugs to specific diseases, for those cases in which there is only one main disease associated with the drug. For example, the table maps the drug “insulin” to the disease “diabetes”.

If successful in determining a new potential health problem for a patient, i.e. when the dispensed drug is disease-specific, the functional entity is operative to automatically add the new potential health problem to the appropriate health problem list stored in the healthcare knowledge database, on the basis of the respective patient identifier.

Note that for prescription drugs that are not disease-specific, i.e. are associated with more than one possible disease, the functional entity will be unable to retrieve an associated ailment from the healthcare knowledge database. As a result, the functional entity will not update any of the health problem lists stored in the healthcare knowledge database.

The physician diagnostic information may be contained in electronic prescription records, ailment lists and aversion lists received from a local clinical source. The functional entity extracts from each electronic prescription record, ailment list and aversion list a patient identifier as well as the indicated ailments, allergies and medication intolerances. The functional entity is operative to automatically update the appropriate health problem list stored in the healthcare knowledge database with the newly determined ailments, allergies and medication intolerances, on the basis of the respective patient identifier.

In yet another broad aspect, the invention provides a healthcare management system implementing an electronic prescription application for generating electronic prescriptions, wherein each electronic prescription is associated with a particular individual and includes at least one clinical indication.

In yet another broad aspect, the invention provides a healthcare management system including a graphical user interface for presenting an electronic prescription pad to a physician via a display. A control entity is operative to generate an electronic prescription on a basis of data input to the electronic prescription pad by the physician, wherein each electronic prescription includes a patient identifier and at least one clinical indication. The system also includes an output adapted to release the electronic prescription.

In yet another broad aspect, the invention provides a computer-readable storage medium containing a program element for execution by a computing device to implement a healthcare management system as described above.

In a specific, non-limiting example of implementation, the healthcare management system implements an electronic prescription generator that provides physicians with a user-friendly electronic prescription pad for prescription entry. The electronic prescription generator includes a functional entity and a graphical user interface. The graphical user interface is responsible for presenting a dynamic electronic pad for prescription entry on a display. The functional entity is operative to process data input to the electronic pad via the graphical user interface for generating an electronic prescription. The functional entity interacts with the healthcare knowledge database in the course of its processing operations, which stores the electronic prescriptions generated by the functional entity.

Each electronic prescription pad identifies the patient and provides fields for entering medication, dosage, administration route, frequency, duration, renewal and treatment information regarding the prescription, among other possibilities. The electronic prescription pad also includes one or more indication data fields that are designated to receive the clinical diagnoses associated with the drug prescription. These clinical diagnoses may take the form of one or more ailments, allergies or medication intolerances with which the patient is or may be afflicted. Alternatively, the clinical diagnosis may simply be a renewal notice.

On the basis of drug-based prescription information that the functional entity obtains from the healthcare knowledge database, the functional entity provides to the physician via the graphical user interface a list of probable clinical indications for the particular drug being prescribed. Thus, in order to fill in the clinical indication field of the prescription, the physician can simply select appropriate clinical indications from a list of probable clinical indications accessible via the electronic prescription pad.

### BRIEF DESCRIPTION OF THE DRAWINGS

The foregoing summary, as well as the following detailed description of the present invention, will be better understood when read in conjunction with the accompanying drawings. It is to be understood, however, that the drawings are provided for purposes of illustration only and not as a definition of the boundaries of the invention, for which reference should be made to the appending claims.

In the drawings:

FIG. 1 shows a healthcare management system in accordance with an example of embodiment of the present invention;

FIG. 2 shows an example screen shot presented via a display to a user of the healthcare management system depicted in FIG. 1;

FIG. 3 shows a detailed information screen that is accessible by interfacing with the elements of the screen shot of FIG. 2;

FIG. 4 shows another example screen shot presented via a display to a user of the healthcare management system depicted in FIG. 1, in accordance with a specific example of implementation of the present invention;

FIG. 5 shows a healthcare management system in accordance with a variant example of embodiment of the present invention;

FIG. 6 shows an example screen shot presented via a display to a user of the healthcare management system depicted in FIG. 5; and

FIG. 7 shows a detailed information screen that is accessible by interfacing with the elements of the screen shot of FIG. 6.

### DETAILED DESCRIPTION

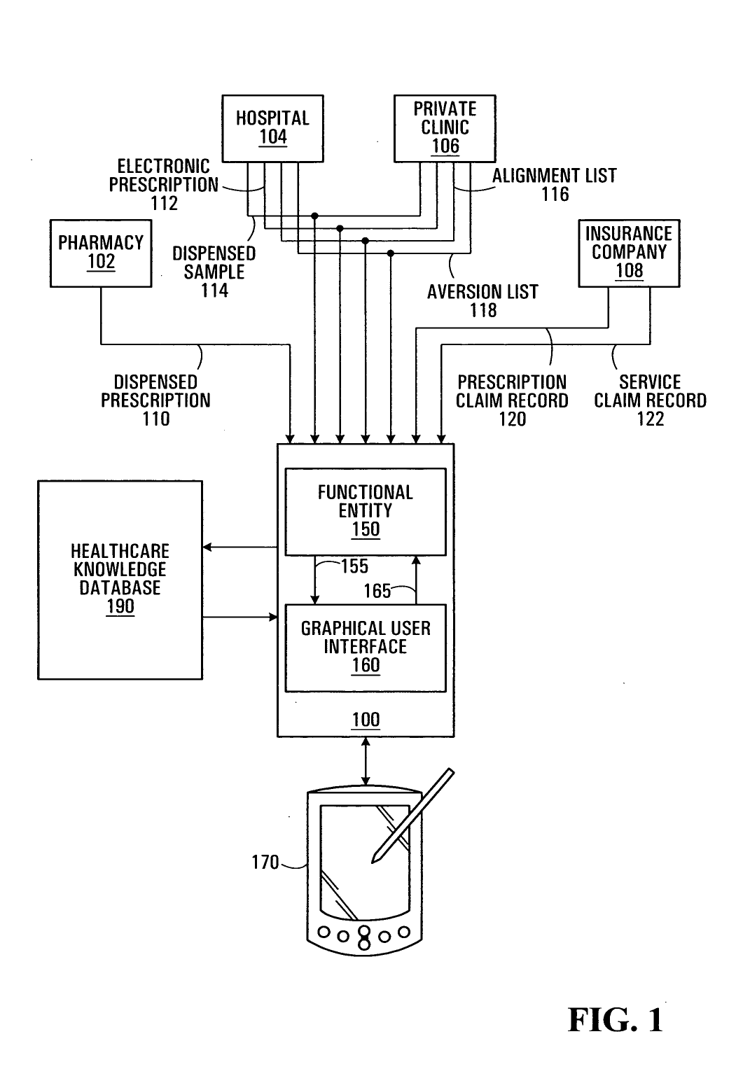

With reference to FIG. 1, there is shown a healthcare architecture including a healthcare management system 100 that is connected to a plurality of information sources 102, 104, 106, 108, according to a non-limiting embodiment of the present invention. The healthcare management system 100 may reside on a secure server that is managed by a government-accredited health care management company. The information sources 102, 104, 106, 108 may be broken down into three main types, namely remote clinical sources (e.g., a pharmacy 102), local clinical sources (such as a hospital 104 or a private clinic 106, etc.) and administrative sources (e.g., an insurance company 108). The information sources 102, 104, 106, 108 provide the healthcare management system 100 with information of varying types and in varying formats. The manner in which the information is conveyed forms no part of the present invention and may include a dedicated link, a secure virtual private network (VPN), an encrypted internet session, a password-protected data exchange, etc.

In the case where the information source is a remote clinical source such as pharmacy 102, the information provided to the healthcare management system 100 relates to claims for drug dispensation, and may take the form of dispensed prescription records 110. Each dispensed prescription record 110 identifies a patient and a prescription drug dispensed to the patient. The dispensed prescription record 110 may also provide a date on which the drug was dispensed, a quantity dispensed, a duration of the prescription (e.g., by way of a number of allowed refills) and a dosage, among other possibilities.

In the case where the information source is a local clinical source such as hospital 104 or private clinic 106, the information provided to the healthcare management system 100 relates to physician diagnoses of patient medical conditions, and may take the form of electronic prescription records 112. Each electronic prescription record 112 identifies a patient, a drug prescribed to the patient, a prescribing physician, the date of the prescription, a quantity prescribed, a duration of the prescription, and a dosage, among other possibilities. Specific to the present invention, each electronic prescription record 112 also includes a clinical diagnosis associated with the drug prescription, in the form of an ailment, allergy or medication intolerance with which the patient is or may be afflicted, as will be discussed in further detail below. Other information that may be supplied by a local clinical source includes an ailment list 116 indicative of ailments with which the patient is afflicted, as well as a list of drugs to which the patient is allergic or with respect to which the patient is intolerant, also referred to as an “aversion list” 118. Both the ailment list 116 and the aversion list 118 include an identification of the concerned patient. In many cases, physicians dispense samples and thus the information provided to the healthcare management system 100 may also be in the form of drug sample records 114 entered by the physician dispensing the sample. Each drug sample record 114 identifies a patient, the sample drug, the identity of the physician dispensing the sample, the date on which the sample was dispensed, the quantity dispensed, the duration of the sample, the dosage and the indication for which it was given, among other possibilities.

In the case where the information source is an administrative source such as an insurance company 108, the information provided to the healthcare management system 100 relates to insurance claims for medical services, and may take the form of medical service claim records 122. Each medical service record 122 identifies a patient and specifies a type of medical service performed (e.g., medical or surgical procedure, etc.) and an indication of a medical condition or ailment for which the medical service was performed. The medical service record 122 may also provide a date on which the service was performed, a location where the service was performed (e.g., ER, inpatient, outpatient), among other possibilities. In addition, an administrative information source may provide the healthcare management system 100 with information relating to claims for drug dispensation, which may take the form of prescription claim records 120, similar to the dispensed prescription records 110 provided by a remote clinical source such as pharmacy 102. Accordingly, each prescription claim record 120 identifies a patient and a drug dispensed to the patient. The prescription claim record 120 may also provide a date on which the drug was dispensed, a quantity dispensed, a duration of the prescription, a dosage and the cost of the drug, among other possibilities.

Specific to the present invention, the healthcare management system 100 implements an “automated health problem list generator” that includes a functional entity 150 and a graphical user interface 160. The functional entity 150, which may also be referred to as a control entity or a control unit, is operative to process information received from the various information sources 102, 104, 106, 108 and produce an output 155. The graphical user interface 160 is responsible for presenting the output 155 received from the functional entity 150 on a display 170. The healthcare management system 100 interacts with one or more reference databases in the course of its processing operations, including a healthcare knowledge database 190. The latter stores the output 155 received from the functional entity 150, as well as other disease and drug-based reference information for use by the functional entity 150.

Non-limiting examples of a suitable display 170 include a PDA, a tablet PC, a laptop display, a desktop display, a touch screen and a pen-based computer, among other possibilities. Also, the graphical user interface 170 may receive input from a user (typically a prescribing physician) via a mouse, keyboard, electronic stylus, finger pressure on the display 170, etc., which is fed as an input 165 to the functional entity 150. The functional entity 150 processes the input 165, resulting in a new output 155 provided to the graphical user interface 160, for presentation on the display 170.

In an example of embodiment of the automated health problem list generator, the information processed by the functional entity 150 includes:
“medical service information” regarding a particular medical service that has been rendered to a patient;
“drug dispensation information” regarding a particular prescription drug that has been dispensed to a patient; and
“physician diagnostic information” regarding a particular diagnosis of the medical condition of a patient that has been given by a physician.

The medical service information is contained in the medical service claim records 122 received from an administrative source, such as a government or private insurance company 108. As previously described, each medical service claim record 122 identifies a patient, a medical service rendered to the patient, an indication of a medical condition or ailment for which the medical service was performed and a date on which the service was performed.

On a basis of the medical service information, the functional entity 150 is operative to determine one or more ailments with which the patient is potentially afflicted. More specifically, the functional entity 150 extracts from each medical service claim record 122 the patient identifier as well as the indication of the medical condition or ailment for which the medical service was performed. This indication of the ailment for which the medical service was performed may take the form of a billing code, medical terminology or a known designation, among other possibilities. The functional entity 150 is capable to convert the indication of the ailment into a health problem designation, if necessary, by consulting the healthcare knowledge database 190, which contains a look-up conversion table mapping indications of ailments to health problem designations.

Therefore, on the basis of the patient identifiers and indications of ailments extracted from the medical service claim records 122, the functional entity 150 is able to automatically generate patient-specific cumulative health problem lists, which are stored in the healthcare knowledge database 190. More specifically, on the basis of the patient identifier, the functional entity 150 adds each new health problem revealed by a medical service claim record 122 to the appropriate health problem list stored in the healthcare knowledge database 190.

The drug dispensation information is contained in the dispensed prescription records 110 received from a remote clinical source (such as a pharmacy 102) and the prescription claim records 120 received from an administrative source (such as an insurance company 108), as well as in the drug sample records 114 received from a local clinical source (such as a hospital 104 or private clinic 106). As previously described, each dispensed prescription record 110, prescription claim record 120 and drug sample record 114 identifies a patient, a drug dispensed to the patient and a date on which the drug was dispensed.

On a basis of the drug dispensation information, the functional entity 150 is operative to attempt to determine one or more ailments with which the patient is potentially afflicted. More specifically, the functional entity 150 extracts from each received record 110, 120, 114 the patient identifier as well as the indication of the prescription drug dispensed to the patient. This indication of the dispensed drug may take the form of a billing code, medical terminology or a known designation, among other possibilities. The functional entity 150 is capable to convert the indication of the dispensed drug into a drug designation, if necessary, by consulting the healthcare knowledge database 190, which in one example may contain a look-up conversion table mapping indications of dispensed drugs to drug designations.

Once the drug designation has been determined, the functional entity 150 will attempt to determine a patient ailment for which the drug was dispensed, by again consulting the healthcare knowledge database 190, which contains drug-disease relationship information. In a specific example, the healthcare knowledge database 190 contains a table mapping prescription drugs to specific diseases, for those cases in which there is only one main disease associated with the drug. For example, the table maps the drug “insulin” to the disease “diabetes”.

Therefore, on the basis of the patient identifiers and indications of dispensed drugs extracted from the records 110, 120, 114, the functional entity 150 attempts to determine health problems with which the patients are potentially afflicted. If successful in determining a new potential health problem for a patient, i.e. when the dispensed drug is disease-specific, the functional entity 150 is operative to automatically add the new potential health problem to the appropriate health problem list stored in the healthcare knowledge database 190, on the basis of the respective patient identifier.

Note that for prescription drugs that are not disease-specific, i.e. are associated with more than one possible disease, the functional entity 150 will be unable to retrieve an associated ailment from the healthcare knowledge database 190. As a result, the functional entity 150 will process received records 110, 120, 114 which concern non-disease-specific drugs dispensed without updating any of the health problem lists stored in the healthcare knowledge database 190.

The physician diagnostic information is contained in the electronic prescription records 112, ailment lists 116 and aversion lists 118 received from a local clinical source, such as a hospital 104 or a private clinic 106. As previously described, each electronic prescription record 112 identifies a patient, a clinical diagnosis associated with the drug prescription (in the form of an ailment, allergy or medication intolerance with which the patient is or may be afflicted), as well as a date of prescription, among other information. Each ailment list 116 identifies a patient and one or more ailments with which the patient is afflicted. Each aversion list 118 identifies a patient and one or more drugs to which the patient is allergic or with respect to which the patient is intolerant.

On a basis of the physician diagnostic information, the functional entity 150 is operative to determine one or more ailments and/or allergies and/or medication intolerances with which the patient is, or potentially is, afflicted. More specifically, the functional entity 150 extracts from each electronic prescription record 112, ailment list 116 and aversion list 118 the patient identifier as well as the indicated ailments, allergies and medication intolerances. The functional entity 150 is operative to automatically update the appropriate health problem list stored in the healthcare knowledge database 190 with the newly determined ailments, allergies and medication intolerances, on the basis of the respective patient identifier.

In a specific example of implementation, the functional entity 150 is capable to identify and delete redundant ailments, allergies and medication intolerances when updating a health problem list stored in the health knowledge database 190.

In another specific example of implementation, the functional entity 150 may add entry-specific qualifiers to each health problem list, where the qualifiers characterise the particular health problems with which they are associated. Such qualifiers may indicate that a particular health problem or allergy is only a potential one (i.e. not yet confirmed or validated by a physician), that a particular allergy is actually a medication intolerance, or that a health problem or allergy does not exist in the healthcare knowledge database 190, among other possibilities.

In yet another specific example of implementation, the functional entity 150 is operative to process only those records 110, 114, 120, 122 for medical services rendered and drugs dispensed within a predetermined period of time, for example within the last twelve months.

The graphical user interface 160 is operative to supply all or a portion of the information contained in a patient's health problem list to the display 170, for presentation in a user-friendly manner. This transmission of all or a subset of a patient's health problem list to the display 170 may occur automatically when a user, typically a physician, initiates a session with the healthcare management system 100. Alternatively, the transmission of all or a subset of a patient's health problem list to the display 170 may occur upon a request input by the physician to the functional entity 150 via the graphical user interface 160.

Note that initiation of a session with the healthcare management system 100 includes inputting to the functional entity 150 a patient identifier, such as a patient's name or medical insurance number, via the graphical user interface 160.

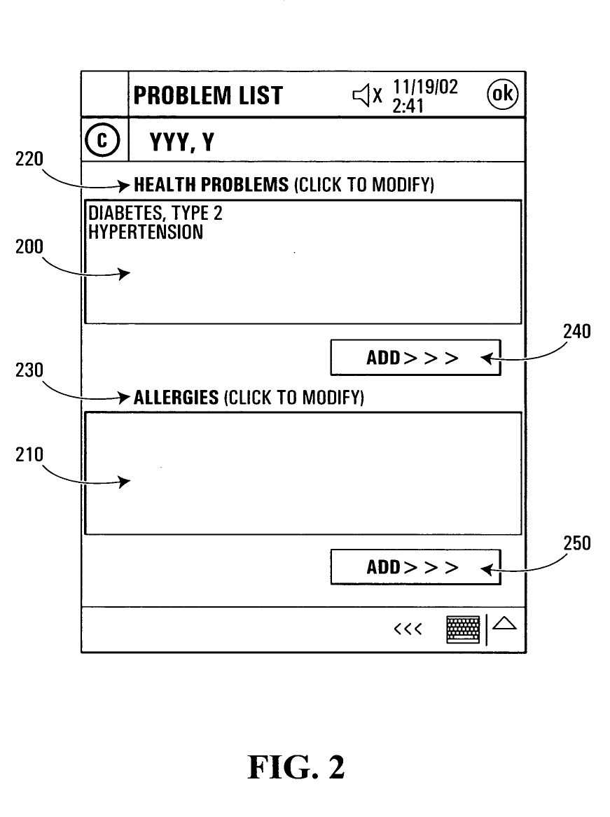

In a non-limiting example of implementation, the graphical user interface 160 displays a health problem list over the display 170 as shown in the screen shot of FIG. 2. In the example shown, the health problem list for a particular patient is displayed in two separate text boxes 200, 210, respectively labelled Health Problems and Allergies. This differentiation between ailments and allergies facilitates reading and practical application of the health problem list by a physician.

Although not shown in the screen shot of FIG. 2, each ailment and allergy appearing in the health problem list may be followed by a qualifier symbol characterising the status of the particular entry. In a specific, non-limiting example:
the symbol “(?)” appears beside every entry which is only a potential problem;
the symbol “*” appears beside every entry which does not exist in the healthcare knowledge database 190;
the symbol “(Intol)” appears beside every allergy which is to be considered as a medication intolerance.

The contents of the displayed health problem list may be controlled through interaction of the user with the graphical user interface 160. By clicking on either one of the labels 220, 230 the user or physician can modify the respective list of ailments or allergies for a patient, including a modification to the status of a particular ailment or allergy. By clicking on one of the Add icons 240, 250 the user of physician can add new entries to the respective list of ailments or allergies. When the user clicks on a label 220, 230 or on an icon 240, 250 the graphical user interface 160 is operative to open a new window, also referred to as an information screen. The information screen prompts the user for the necessary information in order to modify or add to the list of ailments or allergies.

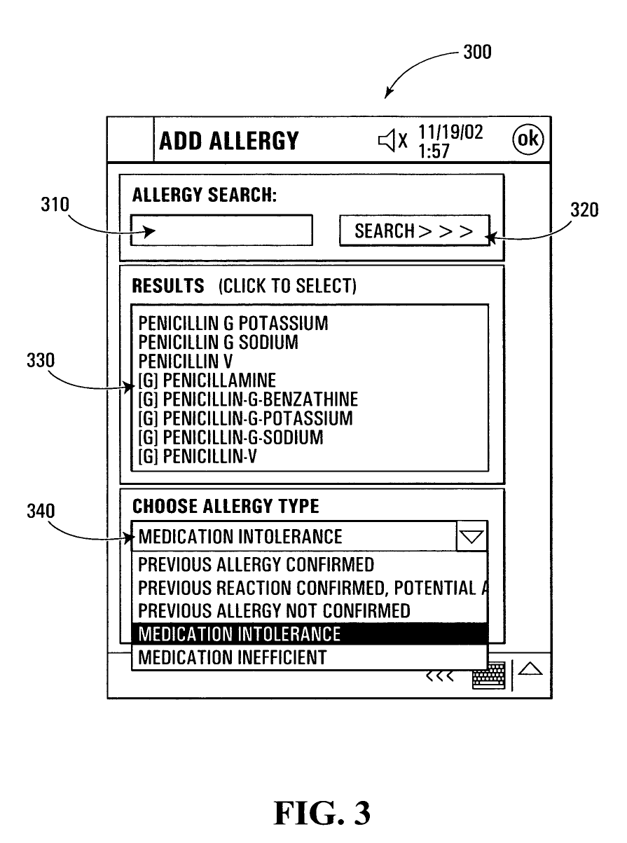

In a specific example, the information screen 300 generated by the graphical user interface 160 when a user clicks on icon 250 is shown in the screen shot of FIG. 3. The physician is able to:
search for a particular allergy, by entering data in the Allergy Search field 310 and clicking on the Search icon 320;
select a particular allergy by clicking on an allergy listed in the Results box 330;
choose an allergy type to be associated with the particular allergy by clicking on one of the types appearing in the drop-down list 340.

Note that the functional entity 150 is operative to search for a particular allergy and provide a list of search results to the physician by submitting a request for such a search to the healthcare knowledge database 190, which contains allergy information, in addition to disease and drug information.

The graphical user interface 160 is operative to transmit to the functional entity 150 the new allergy data input by the user to the information screen 300. The functional entity 150 processes this data and updates the appropriate health problem list stored in the healthcare knowledge database 190 accordingly. As a result, the health problem list displayed on the display 170 is also updated in order to reflect the allergy added to the health problem list by the physician.

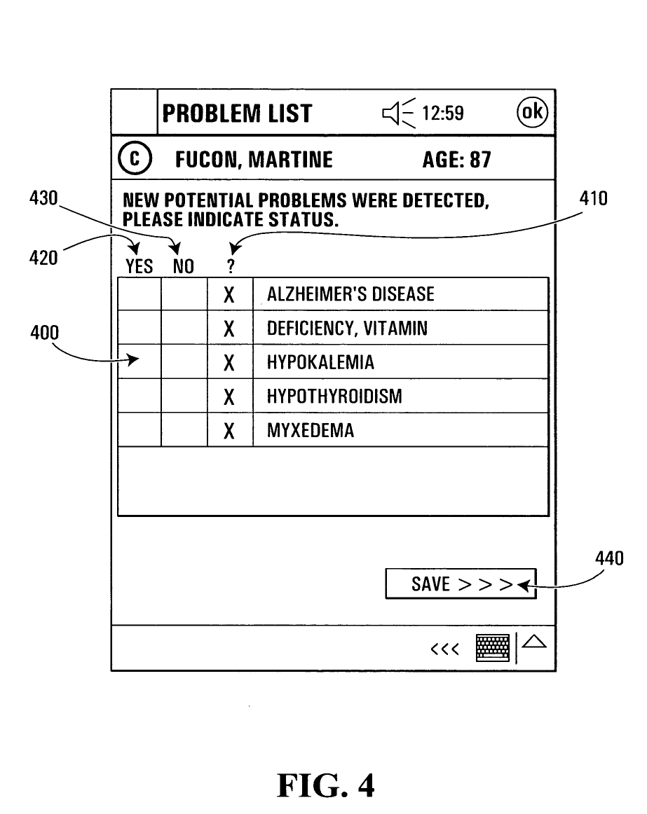

In a non-limiting example of implementation, when a physician initiates a new session with the healthcare management system 100, the functional entity 150 may instruct the graphical user interface 160 to automatically display to the physician over the display 170 a sub-list of the health problem list for the particular patient. An example of this sub-list is shown in the screen shot of FIG. 4. The sub-list displayed in the text box 400 includes all of the ailments detected automatically by the functional entity 150 for the particular patient since the last time a session was run for the particular patient. As described above, these ailments may have been detected by the functional entity 150 upon receiving insurance claims for medical services, drug dispensation claims, electronic prescription records from other physicians, etc.

By default, every entry in the sub-list is initially assigned Potential (“?”) status 410, since the physician has not yet verified and validated the new ailments. At the time of display of the sub-list, the physician is prompted to input validated status information for each ailment. The physician may change the status of one or more of the ailments in the sub-list by clicking on the appropriate portion of the display screen, thereby selecting to confirm (“Yes” status 42) or deny (“No” status 430) that the patient is afflicted with the particular ailment. Any such modifications are transmitted from the graphical user interface 160 to the functional entity 150 when the physician clicks on the Save icon 440. The functional entity 150 processes this data and updates the appropriate health problem list stored in the healthcare knowledge database 190 accordingly.

Those skilled in the art will appreciate that in some embodiments, the functionality of the automated health problem list generator may be implemented as pre-programmed hardware or firmware elements (e.g., application specific integrated circuits (ASICs), electrically erasable programmable read-only memories (EEPROMs), etc.), or other related components. In other embodiments, the automated health problem list generator may be implemented as an arithmetic and logic unit (ALU) having access to a code memory (not shown) which stores program instructions for the operation of the ALU. The program instructions could be stored on a medium which is fixed, tangible and readable directly by the drug profiler, (e.g., removable diskette, CD-ROM, ROM, or fixed disk), or the program instructions could be stored remotely but transmittable to the automated health problem list generator via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

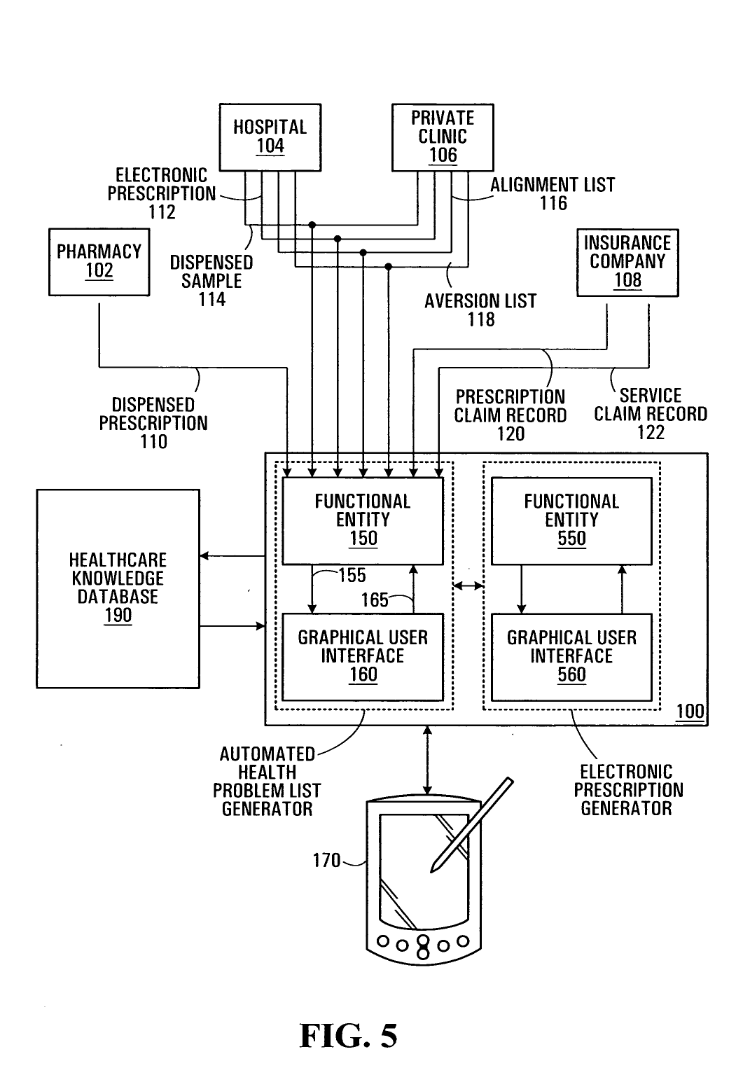

In a variant embodiment of the present invention, the healthcare management system 100 also implements an “electronic prescription generator” that co-operates with the automated health problem list generator, as seen in FIG. 5. The electronic prescription generator provides physicians with a user-friendly electronic prescription pad for prescription entry. Similar to the automated health problem list generator, the electronic prescription generator includes a functional entity 550 and a graphical user interface 560. The graphical user interface 560 is responsible for presenting a dynamic electronic pad for prescription entry on a display 170. The functional entity 550 is operative to process data input to the electronic pad via the graphical user interface 560 for generating an electronic prescription. The functional entity 550 interacts with the healthcare knowledge database 190 in the course of its processing operations, which stores the electronic prescriptions generated by the functional entity 550.

When a physician initiates a session with the healthcare management system 100 and requests generation of an electronic prescription for a particular patient, the functional entity 550 instructs the graphical user interface 560 to display an electronic prescription pad on the display 170. Each electronic prescription pad identifies the patient and provides fields for entering medication, dosage, administration route, frequency, duration, renewal and treatment information regarding the prescription, among other possibilities.

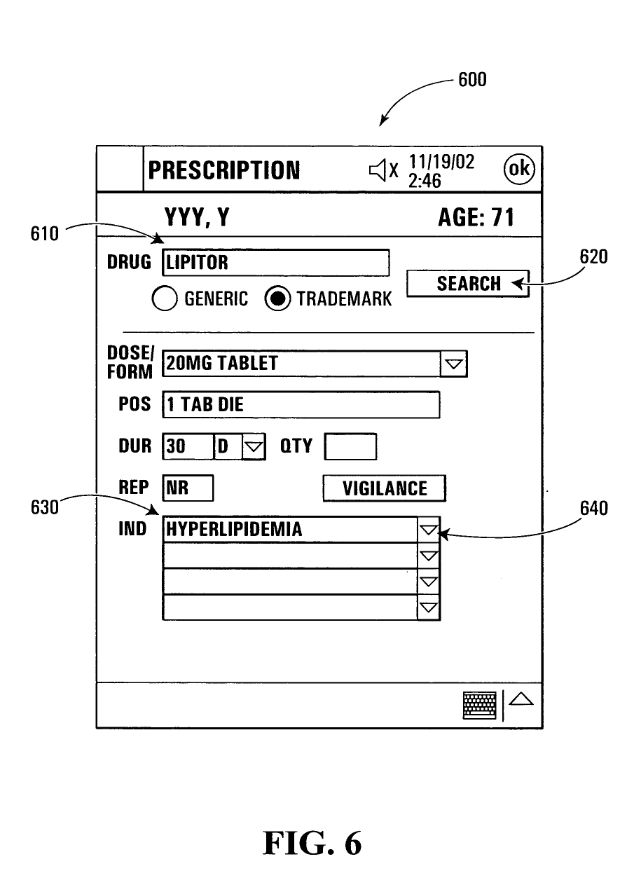

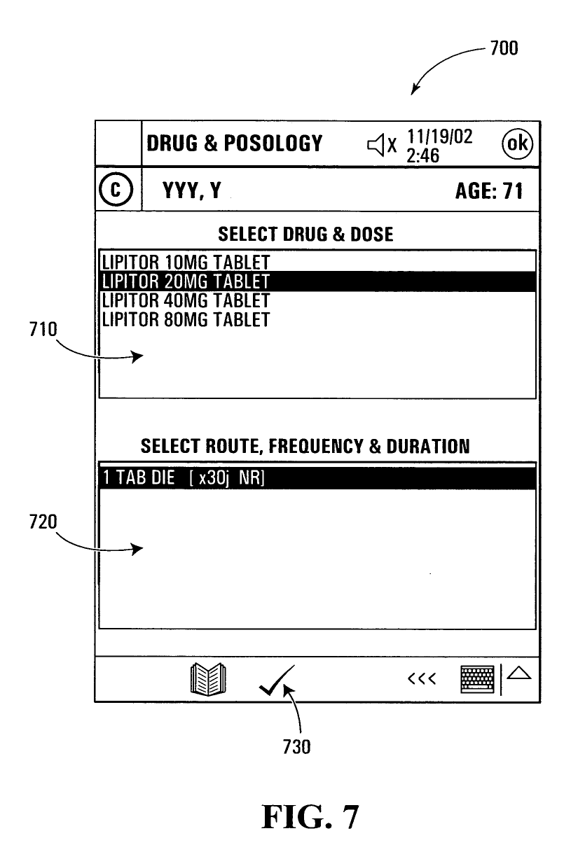

In a non-limiting example of implementation, the graphical user interface 560 displays an electronic prescription pad over the display 170 as shown in the screen shot of FIG. 6. The electronic prescription pad 600 includes a field 610 by which the physician can enter a portion of, or the entire, name of a prescription drug. When the physician clicks on the Search icon 620, the functional entity 550 is operative to provide the physician with a list of possible drugs and their associated posology (i.e. dose, route and frequency), quantity and/or duration information via an information screen, an example of which is shown in FIG. 7. The Drug & Posology screen 700 prompts the physician to make a drug and dosage selection from the upper text box 710, as well as a selection of the combination of posology, quantity and/or duration and number of repeats from the lower text box 720. The functional entity 550 is operative to obtain and provide the results displayed in the Drug & Posology screen 700 by submitting the search request to the healthcare knowledge database 190, which contains predefined, drug-based prescription information. When the physician taps on the check mark 730 at the bottom of the screen 700, the screen 700 closes and functional entity 550 is operative to fill in the fields of the electronic prescription pad on the basis of the data input by the physician to the Drug & Posology screen.

Note that the electronic prescription pad is displayed such that the physician is able to modify any of the data entered into the fields of the electronic prescription pad by the functional entity 550, in order to customize the prescription. Various input methods are available to the physician for making these modifications, including keyboard, block recognizer, letter recognizer, transcriber, etc.

Specific to the present invention, the electronic prescription pad includes one or more indication data fields 630 that are designated to receive the clinical diagnoses associated with the drug prescription. These clinical diagnoses may take the form of one or more ailments, allergies or medication intolerances with which the patient is or may be afflicted. Alternatively, the clinical diagnosis may simply be a renewal notice.

Included with the drug-based prescription information that the healthcare knowledge database 190 returns to the functional entity 550 in response to the search request is a list of probable clinical indications for the particular drug being prescribed. Although not shown in FIG. 6, the functional entity 550 makes these probable clinical indications available to the physician in a drop-down list 640 associated with the indication data field 630. Thus, in order to fill in the clinical indication field of the prescription, the physician can simply select appropriate clinical indications from the drop-down list of probable indications. If a particular clinical indication does not appear in the drop-down list, the physician can input a clinical indication directly in the data field 630.

Once the physician has finalized the electronic prescription, the physician may choose to print a hard copy for the patient. In addition, the physician may also choose to “send” the prescription by clicking on the appropriate icons on the electronic prescription pad, in which case the functional entity 550 transmits the electronic prescription for storage in the healthcare knowledge database 190.

Specific to the present invention, the functional entity 550 also transmits the electronic prescription to the functional entity 150 of the automated health problem list generator. The functional entity 150 is operative to update the health problem list of the particular patient with the clinical indications included in the electronic prescription, as described above with regard to electronic prescription records 112.

Note that the healthcare management system 100 described in the present invention may be implemented as a stand-alone system or as a component of a larger, more complex drug and disease management system.

While specific embodiments of the present invention have been described and illustrated, it will be apparent to those skilled in the art that numerous modifications and variations can be made without departing from the scope of the invention as defined in the appended claims.

1. A healthcare management system, comprising:
an input adapted to receive information regarding insurance claims for medical services, each insurance claim being associated with an individual to whom at least one medical service was provided;
a control unit operative to automatically determine from the information regarding each insurance claim at least one ailment with which the respective individual is potentially afflicted;
an output adapted to release information indicative of said at least one ailment.

2. A healthcare management system as defined in claim 1, wherein said input is adapted to receive the information regarding insurance claims from a government insurer.

3. A healthcare management system as defined in claim 1, wherein said input is adapted to receive the information regarding insurance claims 20 from a private insurer.

4. A healthcare management system as defined in claim 1, wherein said input is adapted to receive some of the information regarding insurance claims from a government insurer and some of the information regarding insurance claims from a private insurer.

5. A healthcare management system as defined in claim 1, wherein said output is adapted to release said information indicative of said at least one ailment to a display and wherein the information released to said display causes display of said at least one ailment for validation by a physician.

6. (canceled)

7. A healthcare management system as defined in claim 1, wherein the information regarding each insurance claim includes an identifier for the respective individual associated with the insurance claim.

8. A healthcare management system as defined in claim 7, wherein the information regarding each insurance claim includes an indication of at least one ailment for which the respective individual received the medical service claimed in the insurance claim.

9. A healthcare management system as defined in claim 8, wherein said control unit is operative to extract from the information regarding each insurance claim said identifier and said indication of at least one ailment.

10. A healthcare management system as defined in claim 9, wherein said control unit is operative to compile a cumulative list of potential ailments for each individual, on a basis of the identifiers and indications of at least one ailment extracted from the information regarding insurance claims for medical services received at said input.

11. A healthcare management system as defined in claim 1, wherein said input is a first input, said healthcare management system further including a second input for receiving information regarding physician diagnoses of patient medical conditions.

12. A healthcare management system as defined in claim 11, wherein said information regarding a physician diagnoses of patient medical conditions includes information selected from the group consisting of: ailments with which a patient is potentially afflicted, ailments with which a patient is afflicted, allergies with which a patient is potentially afflicted, allergies with which a patient is afflicted, medication intolerances with which a patient is potentially afflicted, medication intolerances with which a patient is afflicted.

13. A healthcare management system as defined in claim 12, wherein said control unit is operative to compile a cumulative list of ailments and allergies for each individual, on a basis of the information regarding insurance claims for medical services received at said first input and the information regarding physician diagnoses of patient medical conditions received at said second input.

14. A healthcare management system as defined in claim 11, wherein said information regarding physician diagnoses of patient medical conditions is received from an electronic prescription application.

15. (canceled)

16. A healthcare management system, comprising:
an input adapted to receive information regarding claims for drug dispensation, each claim being associated with an individual to whom at—least one prescription drug was dispensed;
a control unit adapted to automatically attempt to determine from the information regarding each claim one or more ailments with which the respective individual is potentially afflicted;
an output adapted to release information indicative of said one or more ailments.

17. A healthcare management system as defined in claim 16, wherein said information regarding claims for drug dispensation is selected from the group consisting of: information regarding insurance claims for drug dispensation, information regarding pharmaceutical claims for drug dispensation and information regarding physician drug sample records.

18-20. (canceled)

21. A healthcare management system as defined in claim 17, wherein said input is adapted to receive the information regarding pharmaceutical claims from one or more pharmacies.

22. A healthcare management system as defined in claim 16, wherein the information regarding each claim for drug dispensation includes an identifier for the respective individual associated with the claim.

23. A healthcare management system as defined in claim 22, wherein the information regarding each claim for drug dispensation includes an indication of at least one prescription drug dispensed to the respective individual.

24. A healthcare management system as defined in claim 23, wherein said control unit is operative to extract from the information regarding each claim for drug dispensation said identifier and said indication of at least one prescription drug dispensed.

25. A healthcare management system as defined in claim 24, wherein said control unit attempts to determine an ailment with which each individual is potentially afflicted on a basis of said indication of at least one prescription drug dispensed to the respective individual.

26. A healthcare management system as defined in claim 25, wherein said control unit successfully determines the ailment with which the respective individual is potentially afflicted when the prescription drug dispensed to the respective individual is disease specific.

27. A healthcare management system as defined in claim 26, wherein in attempting to determine the ailment with which the respective individual is potentially afflicted, said control unit consults a table mapping prescription drugs to specific diseases.

28. A healthcare management system as defined in claim 24, wherein said control unit is operative to attempt to compile a cumulative list of potential ailments for each individual, on a basis of the identifiers and indications of at least one prescription drug dispensed extracted from the information regarding claims for drug dispensation received at said input.

29. A healthcare management system as defined in claim 16, wherein said input is a first input, said healthcare management system further including a second input for receiving information regarding physician diagnoses of patient medical conditions.

30. A healthcare management system as defined in claim 29, wherein said information regarding a physician diagnoses of patient medical conditions includes information selected from the group consisting of: ailments with which a patient is potentially afflicted, ailments with which a patient is afflicted, is allergies with which a patient is potentially afflicted, allergies with which a patient is afflicted, medication intolerances with which a patient is potentially afflicted, medication intolerances with which a patient is afflicted.

31. A healthcare management system as defined in claim 30, wherein said control unit is operative to compile a cumulative list of ailments and allergies for each individual, on a basis of the information regarding claims for drug dispensation received at said first input and the information regarding physician diagnoses of patient medical conditions received at said second input.

32. A healthcare management system as defined in claim 29, wherein said information regarding physician diagnoses of patient medical conditions is received from an electronic prescription application.

33. (canceled)

34. A healthcare management system, comprising:
a first input adapted to receive information regarding insurance claims for medical services, each insurance claim being associated with an individual to whom at least one medical service was provided;
a second input adapted to receive information regarding claims for drug dispensation, each claim being associated with an individual to whom at least one prescription drug was dispensed
a control unit operative to automatically generate for each individual a cumulative list of ailments with which the respective individual is potentially afflicted, on a basis of the information received at said first and second inputs;
an output adapted to release to a display said cumulative list of ailments for validation by a physician.

35. A healthcare management system as defined in claim 34, wherein said system further includes a third input for receiving information regarding physician diagnoses of patient medical conditions.

36. A healthcare management system as defined in claim 35, wherein said information regarding a physician diagnoses of patient medical conditions includes information selected from the group consisting of: ailments with which a patient is potentially afflicted, ailments with which a patient is afflicted, allergies with which a patient is potentially afflicted, allergies with which a patient is afflicted, medication intolerances with which a patient is potentially afflicted, medication intolerances with which a patient is afflicted.

37. A healthcare management system as defined in claim 36, wherein said control unit is operative to automatically generate a cumulative list of ailments and allergies for each individual, on a basis of the information received at said first, second and third inputs.

38. A healthcare management system as defined in claim 35, wherein said information regarding physician diagnoses of patient medical conditions is received from an electronic prescription application.

39-40. (canceled)

41. A method for generating a list of patient-specific ailments suitable for use in healthcare management, said method comprising:
receiving information regarding claims for drug dispensation, each claim including:
a) an identifier of a patient;
b) an indication of at least one prescription drug dispensed to the respective patient;
extracting from the information regarding each claim the identifier and the indication of at least one prescription drug dispensed;
attempting to determine a potential ailment with which the respective patient is afflicted by consulting a database mapping prescription drugs to specific diseases on a basis of the indication of at least one prescription drug dispensed extracted from the information regarding each claim;
when potential ailments with which respective patients are afflicted are determined, compiling a cumulative list of potential ailments for each respective patient on a basis of the identifiers extracted from the information regarding claims for drug dispensation.

42. A healthcare management system implementing an electronic prescription application for generating electronic prescriptions, wherein each electronic prescription is associated with a particular individual and includes at least one clinical indication.

43. A healthcare management system as defined in claim 42, wherein said clinical indication is an ailment with which the particular individual is potentially afflicted.

44. A healthcare management system as defined in claim 42, wherein said clinical indication is an allergy with which the particular individual is potentially afflicted.

45. (canceled)

46. A healthcare management system, comprising:
a graphical user interface for presenting an electronic prescription pad to a physician via a display;
a control entity operative to generate an electronic prescription on a basis of data input to the electronic prescription pad by the physician, wherein each electronic prescription includes a patient identifier and at least one clinical indication;
an output adapted to release said electronic prescription.

47. A healthcare management system as defined in claim 46, wherein said electronic prescription pad includes at least one clinical indication data field designated to receive clinical indication information.

48. A healthcare management system as defined in claim 47, wherein said clinical indication information is selected from the group consisting of ailments, allergies and medical intolerances.

49. A healthcare management system as defined in claim 47, wherein said clinical indication information is a renewal notice.

50. A healthcare management system as defined in claim 46, wherein said electronic prescription pad includes a drug data field and at least one clinical indication data field, said control entity being operative to generate a list of probable clinical indications on a basis of the data input to said drug data field by the physician.

51. A healthcare management system as defined in claim 50, wherein said control entity is operative to consult a database storing predefined drug-related prescription information in order to generate said list of probable clinical indications.

52-53. (canceled)

54. A computer-readable storage medium containing a program element for execution by a computing device to implement a healthcare management system, said healthcare management system including an electronic prescription application for generating electronic prescriptions, wherein each electronic prescription is associated with a particular individual and includes at least one clinical indication.

55. (canceled)
